(19) United States
(12) Patent Application Publication
(10) Pub. No.: US 2008/0281681 A1
(43) Pub. Date: Nov. 13, 2008

(54) COMPENSATING PARTICIPANTS OF A MULTI-LEVEL SALES FORCE

(76) Inventors: Robert G. Bremner, Mechanicsville, VA (US); Arthur E. Phelos, Massapequa, NY (US); Robert J. Phelos, Lindenburst, NY (US); Matthew W. Yonan, Delano, MN (US); Blair S. Bremner, Richmond, VA (US)

Correspondence Address: Thomas & Raring, P.C., 536 GRANITE AVENUE, RICHMOND, VA, 23226, US

(21) Appl. No.: 12/117,894

(22) Filed: May 9, 2008

Related U.S. Application Data
(60) Provisional application No. 60/917,077, filed on May 10, 2007.

(51) Int. Cl. G06Q 10/00

(52) U.S. Cl. 705/11

(57) ABSTRACT

The present invention provides a unique compensation plan for a multi-level sales force. This plan is a balanced matrix that combines the ability for participants to get paid not only on their personal down line but also on the entire matrix. This plan removes the limits found in other compensation plans by integrating a multi-level, unlimited depth matrix with individual bonus overrides on the entire matrix structure.

### CROSS-REFERENCE TO RELATED APPLICATIONS

This application claims priority to U.S. Provisional Application No. 60/917,077, filed May 10, 2007, the contents of which are incorporated herein by reference in its entirety.

### BACKGROUND

Multi-level marketing, or network marketing, describes a method of direct selling of products, goods, and/or services through a network of sales people that earn overrides or commissions on sales made by other people they recruit into their sales team as well as their own sales. For more than 60 years, this method of direct selling has been used with great success in the United States and around the world.

The early sales teams were almost exclusively structured in what has become known as a unilevel structure. In this configuration, all of a participant's personal recruits into the program are positioned on the first level of their sales team. If these people also recruit other people they would fall on the original person's second level, and so on.

Later, as more and more companies began to sell their products and/or services in this manner, variations of the sales team structure were developed. Since most companies pay commissions on several levels it is beneficial to have sales people on lower levels, since theoretically, there is the potential for an exponentially larger number of sales people on each progressively lower level.

In order to take advantage of this feature of the down line structure, a sales team structure known as a “matrix” was developed. In this type of configuration, the number of sales people on each level in the structure is limited to a fixed number. For example, in a simple “two-by” matrix, the number of personally sponsored people allowed on each level is limited to two. This would allow two sales people on level one, four sales people on level two, and so on. This matrix structure is illustrated in FIG. 1 in which participant 10 has two participants (12a, 12b) under him/her in level 1, who in turn each have two participants (14a-14d)under them in level 2, and who in turn each have two participants (16a-16h) under them in level 3.

Some unique features to this type of structure are that when a person recruits more than two people, the extra people have to be placed on a lower level, and “spillover” under previously sponsored recruits. For example, if someone sponsored three people into a “two-by” matrix, their sales team would look like the matrix illustrated in FIG. 2, in which the third recruit is not placed on a level directly under the person who recruited him/her (because that level is “full”) but rather is placed on the next lower level. In the matrix of FIG. 2, the sales made by recruit #3 could be paid to the sponsor as well as to recruit #1.

Many variations of this matrix type of structure have been developed but they all have disadvantages:

1. There is always a theoretical limit to the number of people who can be recruited. For example, the entire population of the earth would not be enough people to fill a “two-by” matrix to the 33rd level. So, the later a person joins the program, the lower they fall in the matrix, and thus the lesser the opportunity.

2. People only earn commissions or overrides on the sales people directly below them, or in their “down line.” Thus, the people at the top of the matrix have a much greater income potential than the people at the bottom of the matrix.

The latter disadvantage is illustrated in FIG. 3, in which the flow of commissions is illustrated by the solid arrows. The person 10 at the top of the matrix earns commissions on the sales of all the people (12a, 12b, 14a-14d, 16a-16h) below him/her (i.e., in his/her down line). In this example, a person (e.g., 16a) at the bottom of the matrix has no down line and until they recruit people and build a down line they will not earn any income.

Historically, this inability of people who join later to earn as much as the ones who joined earlier eventually causes the entire matrix to self-destruct.

### BRIEF SUMMARY

The present invention provides a unique compensation plan that has been termed the “Reversible Matrix.” This new plan is a balanced matrix that combines the ability for participants to get paid not only on their personal down line but also on the entire matrix. The Reversible Matrix system removes the limits found in other compensation plans by integrating a multi-level, unlimited depth matrix with individual bonus overrides on the entire matrix structure.

In one embodiment of the invention, a method is provided for compensating a plurality of participants of a multi-level sales force, each participant being situated on a level of the sales force, each participant's level corresponding to the participant's entry into the sales force relative to other participants. The method comprising the steps of:
collecting, at predetermined time intervals, a royalty fee from each participant in the sales force, regardless of the participant's level, the royalty fee being either (i) a predetermined amount of money or (ii) a predetermined percentage of revenue generated by sales made by the participant;
placing the collected royalty fees into a revenue sharing pool;
predetermining at least one goal that is desirable for participants to reach and a corresponding distribution amount for the goal;
determining, at predetermined time intervals, which participants have reached the goal; and
distributing the predetermined distribution amount from the revenue sharing pool to each participant determined to have reached the goal, regardless of the participant's level.

In one embodiment, the at least one goal comprises enrolling a predetermined number of new participants by an individual participant. In another embodiment, the at least one goal comprises a plurality of goals of increasing difficulty and increased desirability with corresponding increasing distribution amounts. The plurality of goals may comprise a first goal of enrolling a first predetermined number of new participants by an individual participant and a second goal of enrolling a second predetermined number of new participants by an individual participant, the second predetermined number of new participants being larger than the first predetermined number of new participants.

In another embodiment, the at least one goal comprises enrolling a predetermined number of new participants by (i) by an individual participant, (ii) other participants previously enrolled by the individual participant, or (iii) a combination of the individual participant and other participants previously enrolled by the individual participant. The other participants previously enrolled by the individual participant may be limited to three subsequent levels below the individual participant.

In one embodiment, the method may further comprise awarding one or more credits to each participant who purchases a predetermined amount of product in a predetermined amount of time. In such an embodiment, the at least one goal may comprise (i) earning a predetermined number of credits by an individual participant; (ii) enrolling a predetermined number of new participants by an individual participant; or (iii) earning credits and enrolling new participants by an individual participant, such that the sum of the earned credits and the enrolled new participants equals a predetermined number.

In addition to the method for compensating a plurality of participants of a multi-level sales force as described above, other aspects of the present invention are directed to corresponding systems and computer program products for compensating a plurality of participants of a multi-level sales force.

### BRIEF DESCRIPTION OF THE SEVERAL VIEWS OF THE DRAWING(S)

Having thus described the invention in general terms, reference will now be made to the accompanying drawings, which are not necessarily drawn to scale, and wherein:

FIGS. 1-3 illustrate known multi-level marketing system matrixes;

FIG. 4 illustrates a multi-level marketing system matrix, in accordance with embodiments of the present invention;

FIG. 5 is a flowchart illustrating a method for compensating a plurality of participants of a multi-level sales force, in accordance with one embodiment of the present invention; and

FIG. 6 is a schematic block diagram of a computer in which embodiments of the present invention may operate.

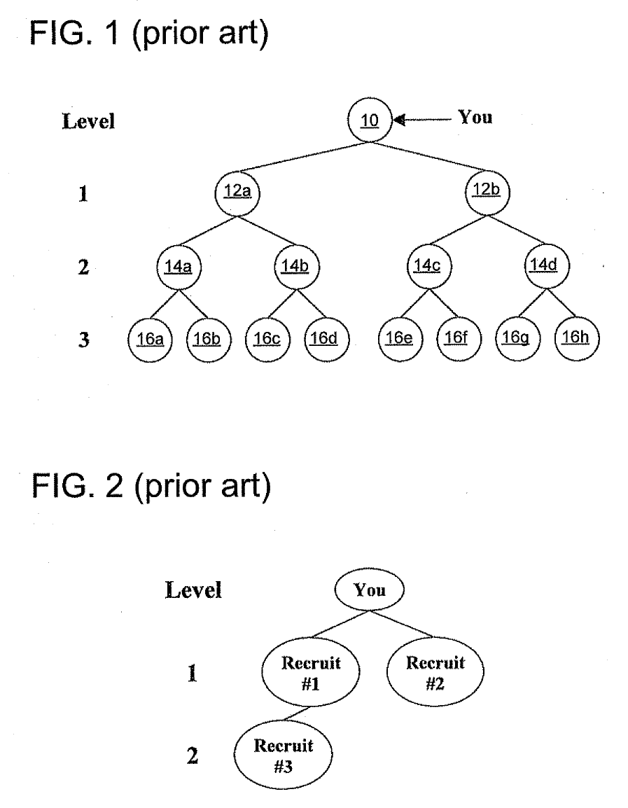

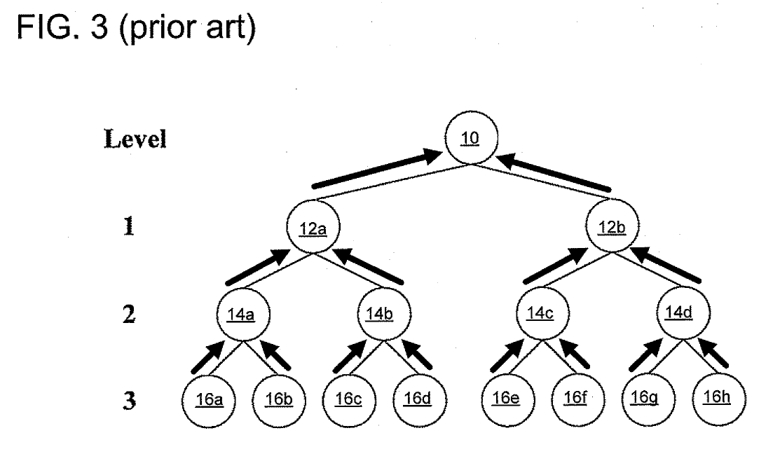

### DETAILED DESCRIPTION

The present invention now will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. Like numbers refer to like elements throughout.

The Reversible Matrix system allows people to have the same income potential regardless of when they join the program or where they are in the down line structure. The Reversible Matrix will allow the person who just joined and is at the bottom of the down line the same opportunity as the people who joined before them and are at the top of the down line. As soon as a person meets certain production qualifications, they can earn overrides on all of the other people in the program, whether they are above them, beside them, or below them. This applies to anyone in the matrix no matter where their position may be. If there are 50,000 people in the matrix and a person joined at the bottom of the matrix, that person would earn commissions on the sales of all 50,000 people as soon as they met the bonus qualification.

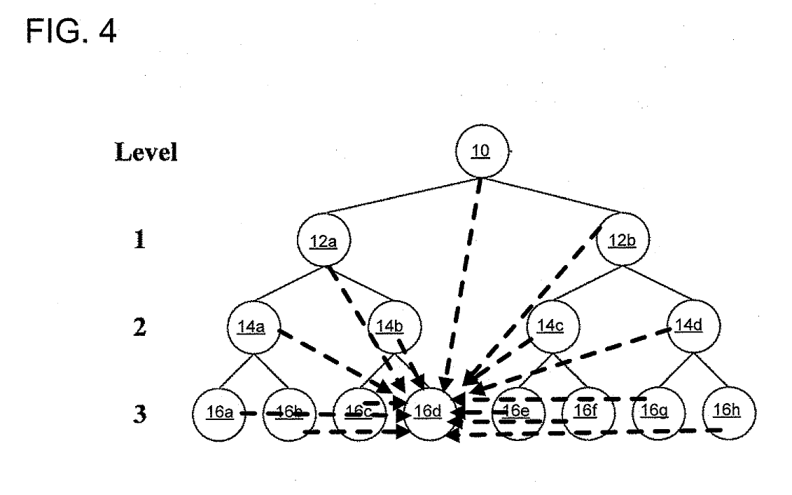

This is illustrated in FIG. 4, in which the flow of a portion of the commissions is illustrated by the dashed arrows. As illustrated in FIG. 4, a person at the bottom of the matrix can earn commissions on the sales of people at all levels. In this example, a person 16a at the bottom of the matrix is able to earn commissions from everyone in the matrix (12a, 12b, 14a-14d, 16a-16c, 16e-16h) despite having no down line.

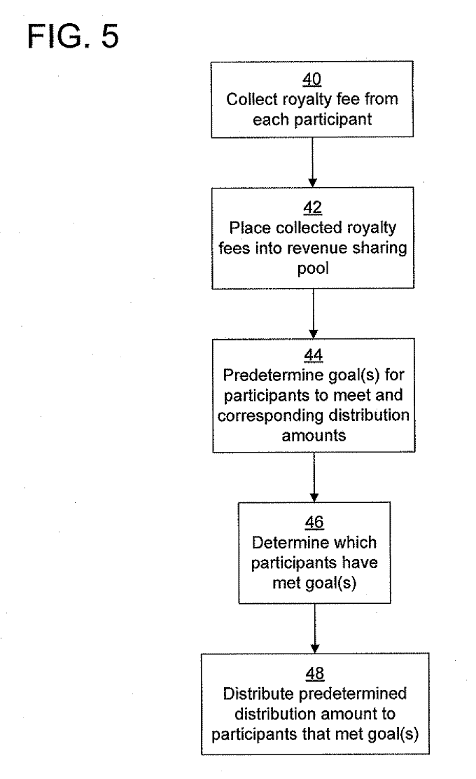

Referring now to FIG. 5, a flowchart illustrates a method for compensating a plurality of participants of a multi-level sales force, in accordance with one embodiment of the present invention. In the method of FIG. 5, a royalty fee is collected, at predetermined time intervals (e.g., monthly), from each participant in the sales force, regardless of the participant's level (block 40). The royalty fee is typically either (i) a predetermined, fixed amount of money or (ii) a predetermined percentage of revenue generated by sales made by each participant. The collected royalty fees are placed into a revenue sharing pool or bonus pool that can be paid to anyone in the matrix that is qualified to receive it (block 42). One or more goals that are desirable for participants to reach are predetermined, along with corresponding distribution amounts for each goal (block 44). A participant is qualified to receive a distribution from the pool if the participant meets one or more of the predetermined goals. Thus, it is determined, at predetermined time intervals (e.g., monthly), which participants have reached the goal(s) (block 46). The predetermined distribution amount corresponding to the goal(s) are then distributed from the revenue sharing pool to each participant determined to have reached the goal, regardless of the participant's level (block 48).

Multiple goals of increasing difficulty and increased desirability may be established with corresponding increasing distribution amounts. A first goal may be, for example, for a participant to enroll a first predetermined number of new participants, and a second goal may be to enroll a second predetermined number of new participants by an individual participant, the second predetermined number of new participants being larger than the first predetermined number of new participants. For example, the first goal could be to personally recruit ten other sales people. All of those who were able to do this would receive an equal share of the bonus pool for that particular qualifier. The second goal could be to personally recruit twenty-five other sales people. All of those who were able to do this would receive an equal share of the bonus pool for that particular qualifier, along with the share for reaching the first goal.

In one embodiment of the invention, the predetermined number of new participants can be enrolled by (i) by an individual participant, (ii) other participants previously enrolled by the individual participant, or (iii) a combination of the individual participant and other participants enrolled by the individual participant, and still be considered to satisfy the goal. The other participants previously enrolled by the individual participant may be limited to, for example, three subsequent levels below the individual participant.

Another feature of embodiments of the invention enables individuals to participate in and receive compensation from a multi-level marketing system, without the requirements of sponsoring others members or selling products. Such a feature may be termed “member credits.” The member credits concept enables members to become and remain active in the compensation plan by buying at least a predetermined number/amount of company products on a regular basis. This feature will typically require such a member to participate in an “auto-ship” program in order to receive member credits. In an auto-ship program, a predetermined number/amount of product is automatically shipped to the member on a predetermined periodic basis (e.g., monthly) until and unless the member cancels.

The longer a member remains active and is buying products, the more member credits he/she will accumulate. Additionally, the number of member credits may be proportional to the number/amount of product the member is buying. For example, a member may earn one member credit every month for buying X amount of product per month, and may earn two member credits every month for 2× amount of product per month.

Once a member accumulates a predetermined number of member credits, the member is rewarded by sharing in monthly bonuses that the company has set aside for such members. In one embodiment, ten member credits are needed to participate in the compensation plan. As described above, the compensation plan may pay a percentage of every established member in the company. The compensation plan may include multiple compensation levels with corresponding higher numbers of credits required and with corresponding higher payments available at each higher level. For example, ten credits may be needed to place a member in the Bronze level, twenty-five credits may be needed to place a member in the Silver level, and fifty credits may be needed to place a member in the Gold level.

As a member continues to stay active and buy the company's products, the member continue to earn more and more member credits. This will allow them to move to the next level in the compensation plan. As they reach the next higher level they in-turn receive a higher percentage of the bonus pools. In one embodiment of the invention, a member may qualify for the compensation plan based on a combination of credits earned for personally sponsoring other members and credits earned for buying product.

Accumulating member credits enables a member to earn money on every established member in the company regardless of whether the member has other members under him/her in the system, or for that matter whether or not the member has sponsored anyone. Moving through the compensation plan of a multi-level or network marketing system typically requires efforts of selling more products and/or sponsoring other members into the business opportunity. With the member credits feature of embodiments of the invention, merely participating in the plan and buying products will enable a member to move through the compensation plan and earn bonuses and income.

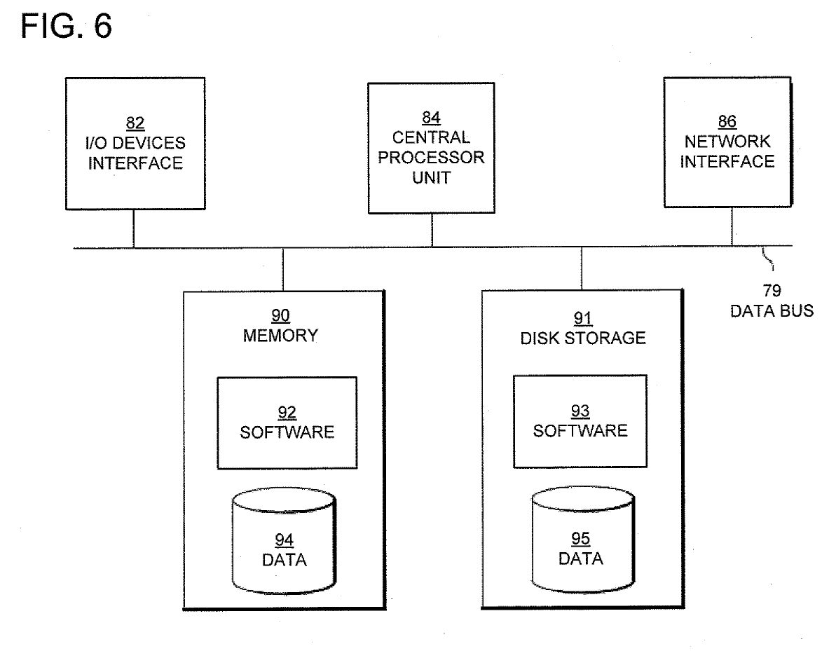

FIG. 6 is a diagram of the internal structure of a computer (e.g., driving computers 50 or controlling computer 60) capable of implementing embodiments of the invention. Each computer typically contains system bus 79, where a bus is a set of hardware lines used for data transfer among the components of a computer. Bus 79 is essentially a shared conduit that connects different elements of a computer system (e.g., processor, disk storage, memory, input/output ports, network ports, etc.) that enables the transfer of information between the elements. Attached to system bus 79 is I/O device interface 82 for connecting various input and output devices (e.g., displays, printers, speakers, etc.) to the computer. Network interface 86 allows the computer to connect to various other devices attached to a network (e.g., network 70 of FIG. 2). Memory 90 provides volatile storage for computer software instructions 92 and data 94 used to implement an embodiment of the present invention. Disk storage 91 provides non-volatile storage for computer software instructions 93 and data 95 used to implement an embodiment of the present invention. Central processor unit 84 is also attached to system bus 79 and provides for the execution of computer instructions.

As will be appreciated by one skilled in the art, the present invention may be embodied as a system, method or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer-usable program code embodied in the medium.

Any combination of one or more computer usable or computer readable mediums(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, etc.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present invention is described herein with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

The flowchart and block diagrams in the figures illustrate the architecture, functionality, and operation of possible implementations of systems, methods and computer program products according to various embodiments of the present invention. In this regard, each block in the flowchart or block diagrams may represent a module, segment, or portion of code, which comprises one or more executable instructions for implementing the specified, logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

“Computer” or “computing device” broadly refers to any kind of device which receives input data, processes that data through computer instructions in a program, and generates output data. Such computer can be a hand-held device, laptop or notebook computer, desktop computer, minicomputer, mainframe, server, cell phone, personal digital assistant, other device, or any combination thereof.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

That which is claimed:

1. A method for compensating a plurality of participants of a multi-level sales force, each participant being situated on a level of the sales force, each participant's level corresponding to the participant's entry into the sales force relative to other participants, the method comprising the steps of:
collecting, at predetermined time intervals, a royalty fee from each participant in the sales force, regardless of the participant's level, the royalty fee being either (i) a predetermined amount of money or (ii) a predetermined percentage of revenue generated by sales made by the participant;
placing the collected royalty fees into a revenue sharing pool;
predetermining at least one goal that is desirable for participants to reach and a corresponding distribution amount for the goal;
determining, at predetermined time intervals, which participants have reached the goal; and
distributing the predetermined distribution amount from the revenue sharing pool to each participant determined to have reached the goal, regardless of the participant's level.

2. The method of claim 1, wherein the at least one goal comprises enrolling a predetermined number of new participants by an individual participant.

3. The method of claim 1, wherein the at least one goal comprises a plurality of goals of increasing difficulty and increased desirability with corresponding increasing distribution amounts.

4. The method of claim 3, wherein the plurality of goals comprises a first goal of enrolling a first predetermined number of new participants by an individual participant and a second goal of enrolling a second predetermined number of new participants by an individual participant, the second predetermined number of new participants being larger than the first predetermined number of new participants.

5. The method of claim 1, wherein the at least one goal comprises enrolling a predetermined number of new participants by (i) by an individual participant, (ii) other participants previously enrolled by the individual participant, or (iii) a combination of the individual participant and other participants previously enrolled by the individual participant.

6. The method of claim 5, wherein the other participants previously enrolled by the individual participant are limited to three subsequent levels below the individual participant.

7. The method of claim 1, further comprising:
awarding one or more credits to each participant who purchases a predetermined amount of product in a predetermined amount of time.

8. The method of claim 7, wherein the at least one goal comprises (i) earning a predetermined number of credits by an individual participant; (ii) enrolling a predetermined number of new participants by an individual participant; or (iii) earning credits and enrolling new participants by an individual participant, such that the sum of the earned credits and the enrolled new participants equals a predetermined number.

9. A system for compensating a plurality of participants of a multi-level sales force, each participant being situated on a level of the sales force, each participant's level corresponding to the participant's entry into the sales force relative to other participants, the system comprising:
a processing element; and
a memory element;
wherein the memory element is configured for storing data regarding a royalty fee collected, at predetermined time intervals, from each participant in the sales force, regardless of the participant's level, the royalty fee being either (i) a predetermined amount of money or (ii) a predetermined percentage of revenue generated by sales made by the participant;
wherein the memory element is configured for storing data regarding a revenue sharing pool in which the collected royalty fees have been placed;
wherein the processing element is configured for determining, at predetermined time intervals, which participants have reached at least one predetermined goal that is desirable for participants to reach; and
wherein the processing element is configured for distributing a predetermined distribution amount corresponding to the predetermined goal from the revenue sharing pool to each participant determined to have reached the goal, regardless of the participant's level.

10. The system of claim 9, wherein the at least one goal comprises enrolling a predetermined number of new participants by an individual participant.

11. The system of claim 9, wherein the at least one goal comprises a plurality of goals of increasing difficulty and increased desirability with corresponding increasing distribution amounts.

12. The system of claim 11, wherein the plurality of goals comprises a first goal of enrolling a first predetermined number of new participants by an individual participant and a second goal of enrolling a second predetermined number of new participants by an individual participant, the second predetermined number of new participants being larger than the first predetermined number of new participants.

13. The system of claim 9, wherein the at least one goal comprises enrolling a predetermined number of new participants by (i) by an individual participant, (ii) other participants previously enrolled by the individual participant, or (iii) a combination of the individual participant and other participants previously enrolled by the individual participant.

14. The system of claim 13, wherein the other participants previously enrolled by the individual participant are limited to three subsequent levels below the individual participant.

15. The system of claim 9, wherein the processing element is further configured for awarding one or more credits to each participant who purchases a predetermined amount of product in a predetermined amount of time.

16. The system of claim 15, wherein the at least one goal comprises (i) earning a predetermined number of credits by an individual participant; (ii) enrolling a predetermined number of new participants by an individual participant; or (iii) earning credits and enrolling new participants by an individual participant, such that the sum of the earned credits and the enrolled new participants equals a predetermined number.

17. A computer program product for compensating a plurality of participants of a multi-level sales force, each participant being situated on a level of the sales force, each participant's level corresponding to the participant's entry into the sales force relative to other participants, the computer program product comprising at least one computer-readable storage medium having computer-readable program code stored therein, the computer-readable program code comprising:
computer-usable program code for storing data regarding a royalty fee collected, at predetermined time intervals, from each participant in the sales force, regardless of the participant's level, the royalty fee being either (i) a predetermined amount of money or (ii) a predetermined percentage of revenue generated by sales made by the participant;
computer-usable program code for storing data regarding a revenue sharing pool in which the collected royalty fees have been placed;
computer-usable program code for determining, at predetermined time intervals, which participants have reached at least one predetermined goal that is desirable for participants to reach; and
computer-usable program code for distributing a predetermined distribution amount corresponding to the predetermined goal from the revenue sharing pool to each participant determined to have reached the goal, regardless of the participant's level.

18. The computer program product of claim 17, wherein the at least one goal comprises enrolling a predetermined number of new participants by an individual participant.

19. The computer program product of claim 17, wherein the at least one goal comprises a plurality of goals of increasing difficulty and increased desirability with corresponding increasing distribution amounts.

20. The computer program product of claim 19, wherein the plurality of goals comprises a first goal of enrolling a first predetermined number of new participants by an individual participant and a second goal of enrolling a second predetermined number of new participants by an individual participant, the second predetermined number of new participants being larger than the first predetermined number of new participants.

21. The computer program product of claim 17, wherein the at least one goal comprises enrolling a predetermined number of new participants by (i) by an individual participant, (ii) other participants previously enrolled by the individual participant, or (iii) a combination of the individual participant and other participants previously enrolled by the individual participant.

22. The computer program product of claim 21, wherein the other participants previously enrolled by the individual participant are limited to three subsequent levels below the individual participant.

23. The computer program product of claim 17, further comprising:
computer-usable program code for awarding one or more credits to each participant who purchases a predetermined amount of product in a predetermined amount of time.

24. The computer program product of claim 23, wherein the at least one goal comprises (i) earning a predetermined number of credits by an individual participant; (ii) enrolling a predetermined number of new participants by an individual participant; or (iii) earning credits and enrolling new participants by an individual participant, such that the sum of the earned credits and the enrolled new participants equals a predetermined number.
